(19) United States
(12) Patent Application Publication
(10) Pub. No.: US 2006/0081709 A1
(43) Pub. Date: Apr. 20, 2006

(54) Structure of image capture device of notebook computer

(75) Inventor: Cheng-Hsiang Chuang, Taipei (TW)

Correspondence Address: BACON & THOMAS, PLLC, 625 SLATERS LANE, FOURTH FLOOR, ALEXANDRIA, VA, 22314, US

(73) Assignee: INVENTEC CORPORATION, Taipei (TW)

(21) Appl. No.: 10/967,153

(22) Filed: Oct. 19, 2004

(51) Int. Cl. G06K 7/10

(52) U.S. Cl. 235/454

(57) ABSTRACT

The present invention is to provide an image capture device comprising two pivotal shafts being mounted respectively on two distal ends thereof for pivotally connecting with pivotal holes on a top end of a screen of a notebook computer, an electromagnetic switch being mounted on an inner circuit thereof, and a magnet being mounted on the top end of the screen of the notebook computer at a position corresponding to a rotation path of the electromagnetic switch. Thus, when the backside of the image capture device is rotated to face a user, the electromagnetic switch is in ON state while the magnet is exactly on a position corresponding to the electromagnetic switch, enabling the circuit thereof to convert a reverse image being captured into an erect image.

### FIELD OF THE INVENTION

The present invention relates to a structure of an image capture device of a notebook computer, more particularly to an image capture device of which the backside is able to be rotated to face the user while a magnet is exactly on a position corresponding to an electromagnetic switch. As a result, the electromagnetic switch is in ON state by magnetic attraction of the magnet, enabling the circuit thereof to convert a reverse image being captured into an erect image.

### BACKGROUND OF THE INVENTION

Generally speaking, a general structure of a conventional image capture device of a notebook computer, as shown in FIG. 1, comprises an image capture device 13 mounted pivotally on a top end 12 of a screen of a notebook computer 11. Two pivotal shafts 14, which are outwardly extending, are mounted respectively on two distal ends of the image capture device 13 that utilizes these two pivotal shafts 14 to pivotally connect with pivotal holes 15 on the top end 12 of the screen of the notebook computer 11. As a result, the image capture device 13 can be rotated on the top end 12. In addition, a push button 16 is mounted on the surface of one pivotal shaft 14 of the image capture device 13 such that the push button 16 is synchronously rotated when the image capture device 13 is rotated. A switch 17, which is electrically connected to he image capture device 13, is mounted on a position corresponding to a rotation path of the push button 16 such that the push button 16 exactly turns on the switch 17 when the backside of the image capture device 13 is rotated to face the user. As a result, the captured reverse image is converted into an erect image by the circuit of the image capture device 13.

According to the aforementioned design, the captured reverse image is indeed converted into the erect image when the backside of image capture device 13 is rotated to face the user. However, the poor interactive movement is caused if the switch 17 is installed on an improper position during the manufacturing process of the notebook computer 11. In other words, the push button 16 cannot turn on the switch 17 and the captured reverse image cannot be converted into the erect image. In addition, the switch 17 is a mechanical device that will produce tolerance because of thermal expansion and cold contraction. As a result, the poor interactive movement is caused. Accordingly, it is necessary to develop and design a structure of an electronic type image capture device to improve the deficiencies taken place in the conventional structure of the image capture device of the notebook computer.

### SUMMARY OF THE INVENTION

In view of such circumstances, the inventor has been made sustained researches and experiments to eventually develop a structure of an image capture device of a notebook computer of the present invention in accordance with the accumulated experience and skill in computer and related peripheral apparatus of the inventor for solving the aforementioned drawbacks of the prior art.

According to one aspect of the present invention, a structure of an image capture device of a notebook computer is provided for improving the aforementioned deficiencies of the prior art. An image capture device is pivotally mounted on a top end of a screen of a notebook computer. Two pivotal shafts, which are outwardly extending, are mounted respectively on two distal ends of the image capture device that utilizes these two pivotal shafts to pivotally connect with pivotal holes on the top end of the screen of the notebook computer. As a result, the image capture device can be rotated on the top end. In addition, an electromagnetic switch is mounted on the inner circuit of the image capture device. A magnet that mates with the electromagnetic switch is mounted on the top end on a position corresponding to a rotation path of the electromagnetic switch.

When the backside of the image capture device is rotated to face the user the magnet is exactly on a position corresponding to the electromagnetic switch. As a result, the electromagnetic switch is in ON state by magnetic attraction of the magnet. Consequently, the captured reverse image is converted into an erect image by the circuit of the image capture device. Accordingly, the installation error or contraction tolerance of conventional mechanical switch, which produces poor interactive movement, can be avoided by using magnetic attraction of the magnet to turn on the electromagnetic switch.

The above and other objects, features and advantages of the present invention will become apparent from the following detailed description taken in conjunction with the accompanying drawings.

### BRIEF DESCRIPTION OF THE DRAWINGS

FIG. 1 is a schematic view showing a conventional image capture device of a notebook computer.

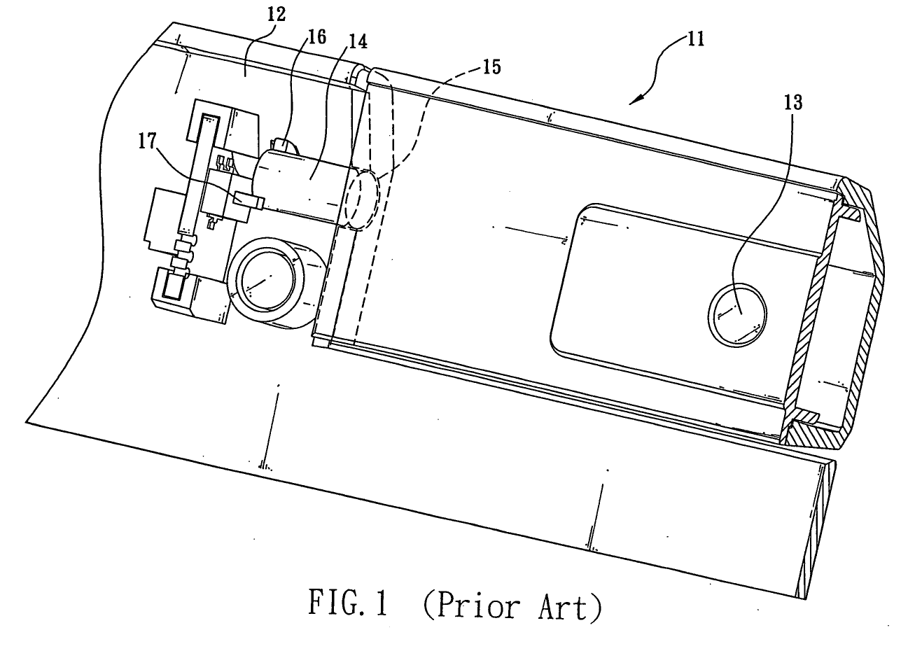

FIG. 2 is a schematic view showing movement of a conventional image capture device of a notebook computer.

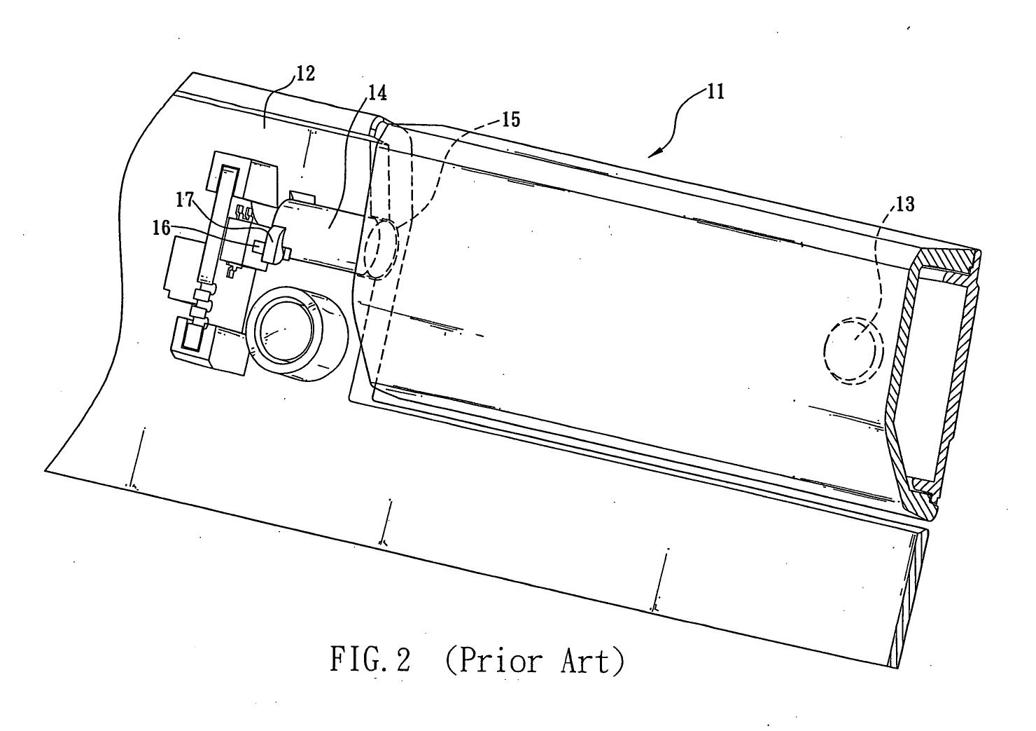

FIG. 3 is a schematic view showing movement of an image capture device of a notebook computer in accordance with the present invention.

FIG. 4 is a schematic view showing an image capture device of a notebook computer in accordance with the present invention.

FIG. 5 is a schematic view showing movement of an image capture device in accordance with the present invention.

### DETAILED DESCRIPTION OF THE PREFERRED EMBODIMENT

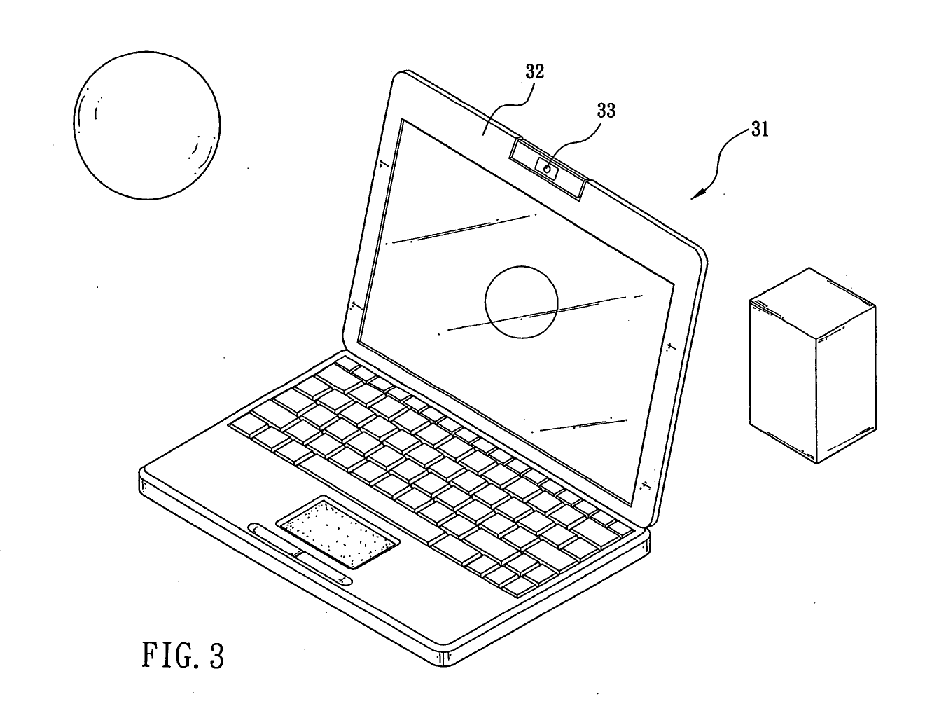

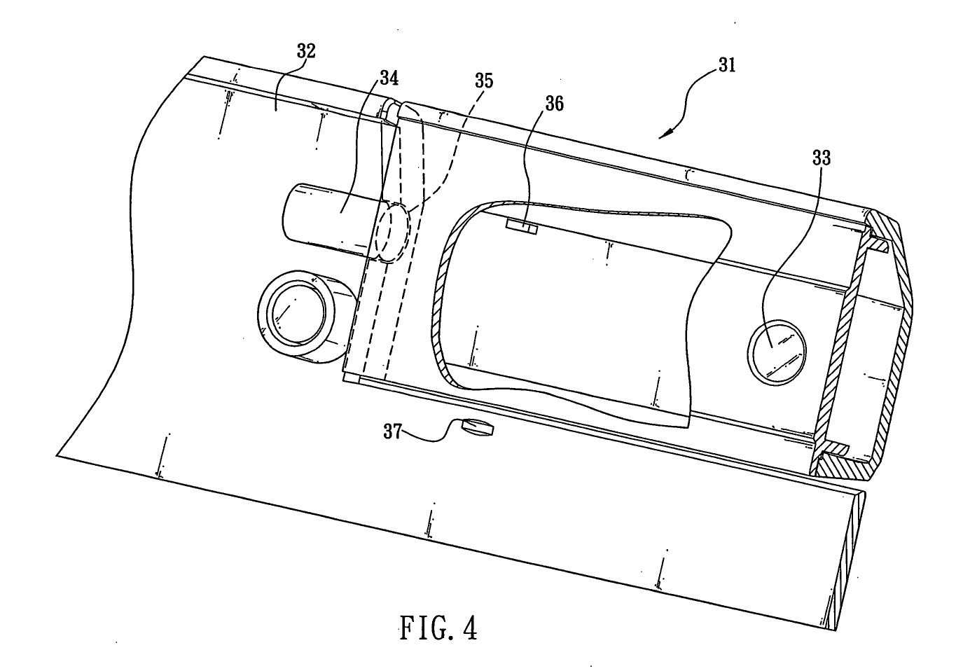

The present invention relates to a structure of an image capture device of a notebook computer. Referring to FIG. 3, this structure mounts an image capture device 33 pivotally on a top end 32 of a screen of a notebook computer 31. The image capture device 33 is pivotally mounted on a notch on the top end 32 such that when the user utilizes the notebook computer 31 the image capture device 33 is applied to capture an user's image or the image capture device 33 is rotated to face the user by its backside for capturing the image of a person opposite to the user. Referring to FIG. 4, two pivotal shafts 34, which are outwardly extending, are mounted respectively on two distal ends of the image capture device 33. The image capture device 33 utilizes these two pivotal shafts 34 to pivotally connect with pivotal holes 35 on the notch of the top end 32 of the screen of the notebook computer 31. As a result, the image capture device 33 can be rotated on the top end 32. An electromagnetic switch 36 is mounted on the inner circuit of the image capture device 33. A magnet 37 that mates with the electromagnetic switch 36 is mounted on the top end 32 on a position corresponding to a rotation path of the electromagnetic switch 36.

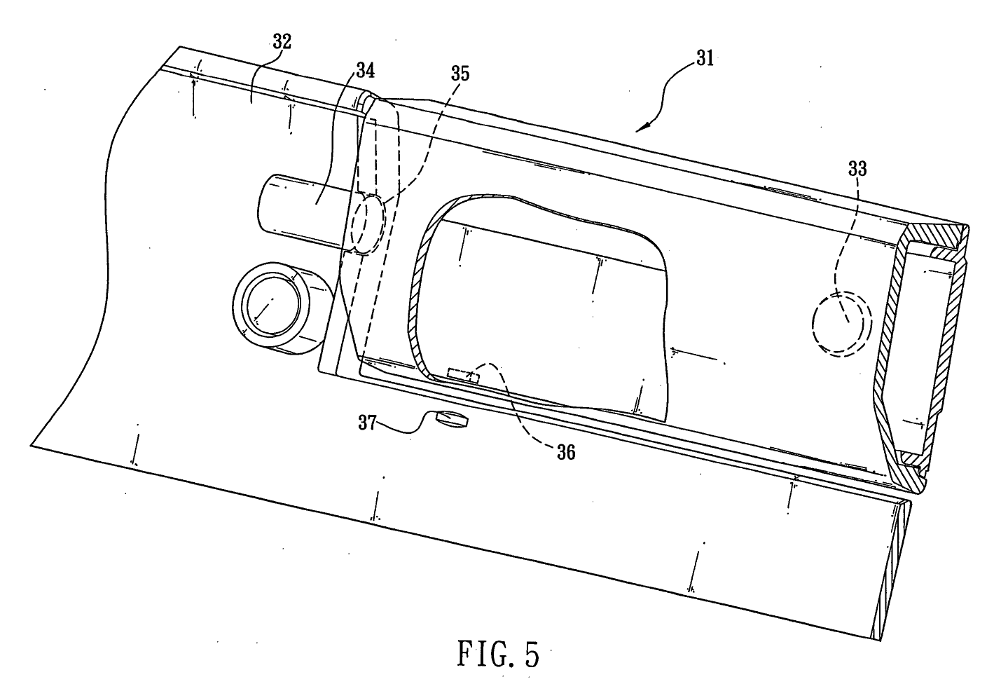

Referring to FIG. 5, when the note computer 31 is utilized to take a photograph the image capture device 33 captures the image of the user. Otherwise, when the backside of the image capture device 33 is rotated to face the user the magnet 37 is exactly mounted on a position corresponding to the electromagnetic switch 36. As a result, the magnet 37 turns on the electromagnetic switch 36 by magnetic attraction. In this manner, the captured reverse image is converted into an erect image by the circuit of the image capture device 33. Consequently, the erect image of the person opposite to the user can be captured.

In the present invention, the magnet 37 is an electromagnet. A coil having a ferric core is mounted on the electromagnet. The coil is electrically connected to the circuit of the notebook computer 31 such that the circuit provides electric power for the coil to excite the electromagnet to produce a magnetic field. When the backside of the image capture device 33 is rotated to face the user the electromagnet is exactly on a position corresponding to the electromagnetic switch 36. As a result, the electromagnet turns on the electromagnetic switch 36 by using magnetic attraction. Consequently, the captured reverse image is converted into an erect image by the circuit of the image capture device 33.

In another preferred embodiment of the present invention, a magnet 37 is mounted on the inner circuit of the image capture device 33. An electromagnetic switch 36 that mates with the magnet 37 is mounted on the top end 32 on a position corresponding to a rotation path of the magnet 37. The electromagnetic switch 36 is electrically connected to the inner circuit of the image capture device 33. When the image capture device 33 is rotated to face the user by its backside the magnet 37 is exactly on a position corresponding to the electromagnetic switch 36. As a result, the electromagnetic switch 36 is in ON state by using magnetic attraction of the magnet 37. Consequently, the captured reverse image is converted into an erect image by the circuit of the image capture device 33.

According to the above description, the installation inaccuracy or contraction tolerance of conventional mechanical switch, which produces poor interactive movement, can be avoided by using magnetic attraction of the magnet 37 to turn on the electromagnetic switch 36. Consequently, the present invention significantly improves the drawbacks of the conventional image capture device of notebook computer. Accordingly, the present invention provides with an incomparable convenience.

While the invention has been described by means of specific embodiments, numerous modifications and variations could be made thereto by those skilled in the art without departing from the scope and spirit of the invention set forth in the claims.

What the invention claimed is:

1. A structure of an image capture device of a notebook computer comprising:
an image capture device mounted pivotally on a notch on a top end of a screen of a notebook computer so as to capture an image of an user through the image capture device or rotate the image capture device to face the user by its backside for capturing an image of a person opposite to the user;
an electromagnetic switch mounted on an inner circuit of the image capture device; and
a magnet mated with the electromagnetic switch and mounted on the top end of the screen of the notebook computer on a position corresponding to a rotation path of the electromagnetic switch, such that when the backside of the image capture device is rotated to face the user, the magnet is exactly on a position corresponding to the electromagnetic switch and turns on the electromagnetic switch by using magnetic attraction for converting a reverse image being captured into an erect image by the circuit of the image capture device.

2. The structure of the image capture device of the notebook computer of claim 1, wherein two pivotal shafts are outwardly extending and mounted respectively on two distal ends of the image capture device, and the image capture device utilizes the two pivotal shafts to pivotally connect with pivotal holes on the notch on the top end of the screen of the notebook computer.

3. The structure of the image capture device of the notebook computer of claim 1, wherein the magnet is an electromagnet and a coil having a ferric core is mounted on the electromagnet, wherein the coil is electrically connected to the circuit of the notebook computer thereby the circuit providing electric power for the coil to excite the electromagnet to produce a magnetic field.
